(19) United States
(12) Patent Application Publication
(10) Pub. No.: US 2026/0051332 A1
(43) Pub. Date: Feb. 19, 2026

(54) ANNOTATING DATA FOR BUILDING CONVERSATIONAL AGENTS REINFORCING POLITENESS USING MULTIPLE AUXILIARY MODELS AND OUT-OF-DISTRIBUTION SAMPLING

(71) Applicant: Dell Products L.P., Round Rock, TX (US)

(72) Inventors: Srishti Gupta, Rohini (IN); Saurabh Jha, Leander, TX (US)

(21) Appl. No.: 18/807,342

(22) Filed: Aug. 16, 2024

(51) Int. Cl. G10L 25/51; G10L 15/06; G10L 15/08

(52) U.S. Cl. CPC G10L 25/51; G10L 15/063; G10L 15/08

(57) ABSTRACT

A method for utterance classification. The method includes: receiving an unclassified utterance; processing the unclassified utterance to produce a politeness score; analyzing the unclassified utterance to produce a key linguistic terms count; making a first determination that the politeness score exceeds a politeness score threshold; making a second determination, based on the first determination, that the key linguistic terms count exceeds a key linguistic terms count threshold; and classifying, based on the second determination, the unclassified utterance as a polite utterance.

### BACKGROUND

In the current era, customers spend considerable amount of time in digital environments, so much so that companies prioritize being online anytime and anywhere to keep in touch with their customers. An instrument to respond to digitization and customer experience is through the use of chat-bots.

### SUMMARY

In general, in one aspect, embodiments described herein relate to a method for utterance classification. The method includes: receiving an unclassified utterance; processing the unclassified utterance to produce a politeness score; analyzing the unclassified utterance to produce a key linguistic terms count; making a first determination that the politeness score exceeds a politeness score threshold; making a second determination, based on the first determination, that the key linguistic terms count exceeds a key linguistic terms count threshold; and classifying, based on the second determination, the unclassified utterance as a polite utterance.

In general, in one aspect, embodiments described herein relate to a non-transitory computer readable medium (CRM). The non-transitory CRM includes computer readable program code, which when executed by a computer processor, enables the computer processor to perform a method for utterance classification. The method includes: receiving an unclassified utterance; processing the unclassified utterance to produce a politeness score; analyzing the unclassified utterance to produce a key linguistic terms count; making a first determination that the politeness score exceeds a politeness score threshold; making a second determination, based on the first determination, that the key linguistic terms count exceeds a key linguistic terms count threshold; and classifying, based on the second determination, the unclassified utterance as a polite utterance.

In general, in one aspect, embodiments described herein relate to a method for out-of-distribution data generalization. The method includes: selecting, of a polite dialog service, a polite dialog service module including module weights; creating a new polite dialog service module including new module weights; processing a first portion of a module input-target sample using the polite dialog service module to produce a module prediction value; processing a second portion of the module input-target sample using the new polite dialog service module to produce a new module prediction value; computing a de-biasing loss from the module prediction value, the new module prediction value, and a third portion of the module input-target sample; making a determination that the de-biasing loss falls below a de-biasing loss threshold; and deeming, based on the determination, the polite dialog service module as generalized for out-of-distribution data.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1A shows a system in accordance with one or more embodiments described herein.

FIG. 1B shows a client device in accordance with one or more embodiments described herein.

FIG. 1C shows a polite dialog service in accordance with one or more embodiments described herein.

FIG. 2A shows a polite dialog service training environment in accordance with one or more embodiments described herein.

FIG. 2B shows a response generator training scheme in accordance with one or more embodiments described herein.

FIGS. 3A and 3B show a flowchart outlining a method for annotated data generation in accordance with one or more embodiments described herein.

FIG. 4 shows a flowchart outlining a method for unclassified utterance classification in accordance with one or more embodiments described herein.

FIGS. 5A and 5B show a flowchart outlining a method for polite dialog service module generalization in accordance with one or more embodiments described herein.

FIG. 6 shows a computing system in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to annotating data for building conversational agents reinforcing politeness using multiple auxiliary models and out-of-distribution sampling. Particularly, in the current era, wherein customers spend considerable amount of time in digital environments, companies prioritize being online anytime and anywhere to keep in touch with their customers. An instrument to respond to digitization and customer experience is the use of chat-bots. Today's consumers have less time and higher demands than ever before and to retain their interest, loyalty, and share of wallet, businesses need to start thinking about voice as part of their strategy.

For a voice assistant to conduct fluent, near-human-like conversations and enable smooth, helpful interactions with its users, it needs to be trained with data that is specific to its purpose. This data is sourced and structured through a combination of workflows that include speech collection, transcription, annotation and tagging, with various stages of validation along the way. To build a robust conversational agent, there is a need for annotated data. The annotation process needs to be standardized, such that data can be used in producing accurate models. Such annotated data can be used in multiple tasks like domain identification, domain state tracking, information identification, action generation, response generation, and error controlling.

The success of any conversational agent is measured by politeness of the conversational agent. Impolite responses may cause huge customer dissatisfaction rates. Proper use of adjectives and pronouns is very important in generating polite and relevant responses. Another aspect to the solution is out-of-distribution generalization. To get out-of-distribution generalization, models focus on the compression techniques that includes pruning, knowledge distillation, parameter sharing, quantization etc. These techniques can be combined to single architecture with learning weighted sparse matrix and de-biasing loss function.

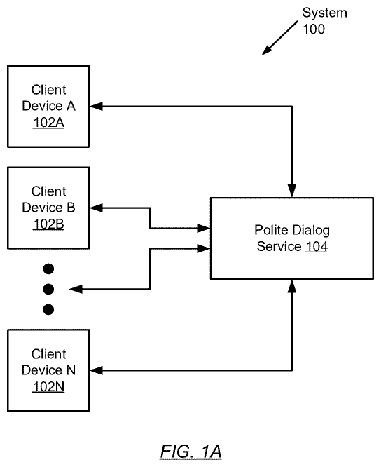

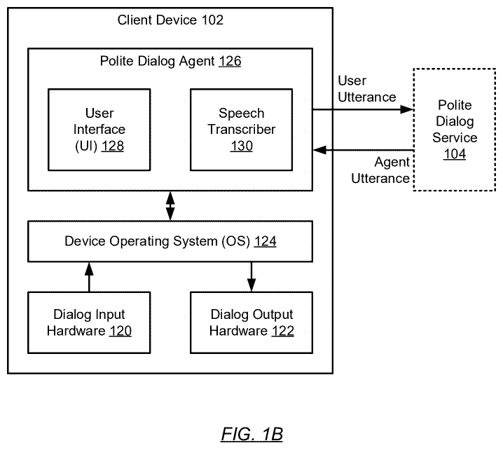

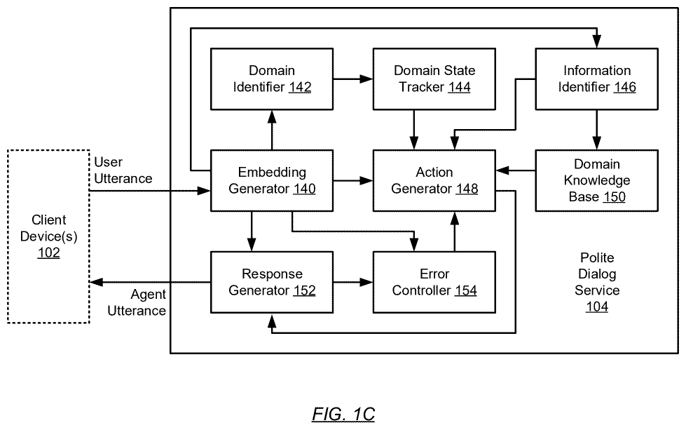

FIG. 1A shows a system in accordance with one or more embodiments described herein. The system (100) includes one or more client devices (102A-102N) and a polite dialog service (104). Each of these system (100) components is described below.

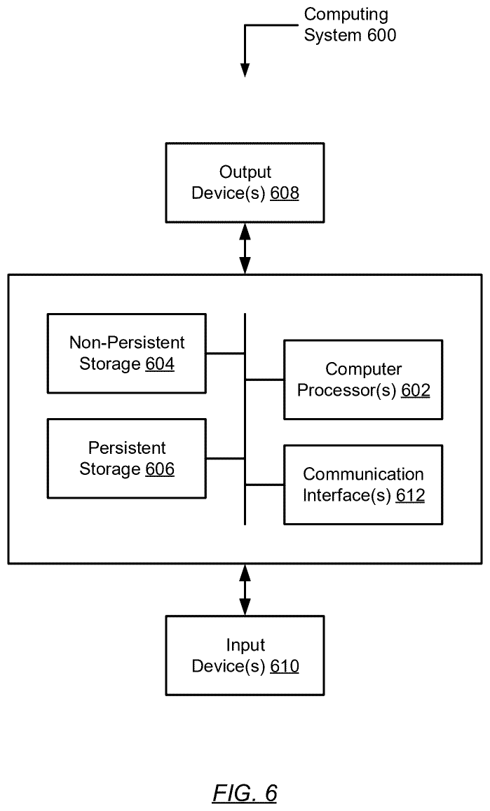

In one or many embodiment(s) described herein, any client device (102A-102N) represents a physical computing device configured to receive, generate, process, store, and/or transmit data, as well as provide an environment in which one or many workload(s) may be performed thereon. Any said workload (not shown) refers, but is not limited, to a service offered locally and/or over a network (not shown), a computational task/function, or a data transaction. One of ordinary skill, however, will appreciate that any client device (102A-102N) may perform other functionalities without departing from the scope of the embodiments described herein. Any client device (102A-102N) is illustrated and described in additional detail with respect to FIG. 1B, below. Examples of any client device (102A-102N) include, but are not limited to, a desktop computer, a laptop computer, a tablet computer, a smartphone, a smartwatch, and any other computing device similar to the exemplary computing system illustrated and described below with respect to FIG. 6.

In one or many embodiment(s) described herein, the polite dialog service (104) represents enterprise information technology (IT) infrastructure configured to support polite dialog agents deployed on the client device(s) (102A-102N). Said support may be directed to maintaining polite dialogues with the user(s) of the client device(s) (102A-20N) across one or more knowledge domains (e.g., product manufacturing, healthcare, banking, entertainment, travel, food, etc.). One of ordinary skill, however, will appreciate that the polite dialog service (104) may perform other functionalities without departing from the scope of the embodiments described herein. The polite dialog service (104), furthermore, may be implemented through on-premises infrastructure, cloud computing infrastructure, or any hybrid infrastructure thereof. Accordingly, the polite dialog service (104) may be implemented using one or more network servers (not shown), where each network server represents a physical or a virtual network server. Additionally, or alternatively, the polite dialog service (104) may be implemented using one or more computing devices similar to the exemplary computing system illustrated and described with respect to FIG. 6, below. The polite dialog service (104) is illustrated and described in additional detail below with respect to FIG. 1C.

In one or many embodiment(s) described herein, the above-mentioned system (100) components (or subcomponents thereof) may communicate with one another through a network (not shown) (e.g., a local area network (LAN), a wide area network (WAN) such as the Internet, a mobile network, any other network type, or any combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components (or subcomponents thereof). Moreover, in communicating with one another, the above-mentioned system (100) components (or subcomponents thereof) may employ any combination of wired and/or wireless communication protocols.

While FIG. 1A shows a configuration of components and/or subcomponents, other system (100) configurations may be used without departing from the scope of the embodiments described herein.

FIG. 1B shows a client device in accordance with one or more embodiments described herein. The client device (102) includes dialog input hardware (120), dialog output hardware (122), a device operating system (OS) (124), and a polite dialog agent (126). Each of these client device (102) subcomponents is described below.

In one or many embodiment(s) described herein, the dialog input hardware (120) represents one or more input devices each configured to enable any user(s) of the client device (102) to enter information of a given modality (e.g., text, audio, etc.). Any said entered information may allow said user(s) to engage in conversations with the polite dialog agent (126). Examples of the dialog input hardware (120) include a keyboard and a microphone.

In one or many embodiment(s) described herein, the dialog output hardware (122) represents one or more output devices each configured to enable any user(s) of the client device (102) to receive information of a given modality (e.g., text, audio, etc.). Any said received information may allow the polite dialog agent (126) to engage in conversations with said user(s). Examples of the dialog output hardware (122) include a display and an audio speaker.

In one or many embodiment(s) described herein, the device OS (124) represents a computer program, or computer readable instructions, which when executed or invoked, perform(s) one or more tasks responsible for overseeing client device (102) operations. To said extent, and at least in part, the device OS (124) includes functionality to: schedule fundamental client device (102) functions; mediate interactivity between any logical (e.g., polite dialog agent (126)) component(s) and any physical (e.g., dialog input hardware (120) and dialog output hardware (122)) component(s) of the client device (102); allocate and/or de-allocate any granularity of client device (102) resources (e.g., computer processors, memory, storage, virtualization, network bandwidth, etc.) as needed to service any number of received system calls; and execute or invoke other computer program(s) and/or computer readable instructions. One of ordinary skill, however, will appreciate that the device OS (124) may perform other functionalities without departing from the scope of the embodiments described herein.

In one or many embodiment(s) described herein, the polite dialog agent (126) represents a computer program, or computer readable instructions, which when executed or invoked, perform(s) one or more tasks directed to maintaining polite dialogues with any user(s) of the client device (102) across one or more knowledge domains. To said extent, the polite dialog agent (126) includes functionality to: capture user utterances (e.g., in text or audio from) entered by said user(s); transmit said user utterances to the polite dialog service (104) for processing; receive agent utterances from the polite dialog service (104) representing polite responses to said user utterances; and provide said agent utterances (e.g., in text or audio form) to said user(s). One of ordinary skill, however, will appreciate that the polite dialog agent (126) may perform other functionalities without departing from the scope of the embodiments described herein.

In one or many embodiment(s) described herein, the polite dialog agent (126) includes a user interface (UI) (128) and a speech transcriber (130), which facilitate the polite dialog agent (126) in conducting its functionalities. The UI (128) represents a computer program, or computer readable instructions, which when executed or invoked, implement(s) a graphical interface through which any user(s) of the client device (102) may engage with the polite dialog agent (126). The speech transcriber (130), meanwhile, represents a computer program, or computer readable instructions, which when executed or invoked, convert(s) any audio based user utterance(s) into text based user utterance(s)—the latter of which is/are submitted to the polite dialog service (104) for processing. Additionally, the speech transcriber (130) may conversely convert any text based agent utterance(s) into audio based agent utterance(s) (if required or preferred) received from the polite dialog service (104), where either or both formats may subsequently be provided to any user(s) of the client device (102).

While FIG. 1B shows a configuration of components and/or subcomponents, other client device (102) configurations may be used without departing from the scope of the embodiments described herein.

FIG. 1C shows a polite dialog service in accordance with one or more embodiments described herein. The polite dialog service (104) includes an embedding generator (140), a domain identifier (142), a domain state tracker (144), an information identifier (146), an action generator (148), a domain knowledge base (150), a response generator (152), and an error controller (154). Each of these polite dialog service (104) subcomponents is described below.

In one or many embodiment(s) described herein, the embedding generator (140) represents a computer program, or computer readable instructions, which when executed or invoked, perform(s) text vectorization entailing the translation of text sentences (e.g., user utterances) to numerical representations (or text embeddings) thereof. To said extent, and at least within the production setting of the polite dialog service (104), the embedding generator (140) includes functionality to: receive text based user utterances from any client device(s) (102); process said text based user utterances using text vectorization (described below) to produce text embeddings; and provide said text embeddings to one or more other polite dialog service (104) subcomponents (e.g. domain identifier (142), information identifier (146), action generator (148), response generator (152), and error controller (154)) to assist in their respective functionalities.

In one or many embodiment(s) described herein, any text embedding may be expressed as a vector or array reflecting an ordered sequence of numbers, where the vector/array may be of any arbitrary size (i.e., have any number of vector/array elements). Further, each numerical value forming said text embedding may reference a dimension (i.e., often depicted as a word) within a vocabulary (i.e., any number of unique words) chosen from a corpus (i.e., collection of texts in the one or more knowledge domains). The numerical values themselves may each, for example, indicate: whether the corresponding dimension/word appears in a given sentence (where the vector/array is described as sparse); or a frequency of said dimension/word that appears in the given sentence (where the vector/array is described as dense).

In one or many embodiment(s) described herein, the domain identifier (142) represents a computer program, or computer readable instructions, which when executed or invoked, perform(s) intent classification entailing the recognition of the intent(s) underlying any text embedding(s). To said extent, and at least within the production setting of the polite dialog service (104), the domain identifier (142) includes functionality to: obtain text embeddings from the embedding generator (140); process said text embeddings using intent classification (described below) to produce intents (or intent tags thereof); and provide said intents/intent tags to the domain state tracker (144) for interpretation.

In one or many embodiment(s) described herein, intent classification refers to a natural language processing (NLP) technique that utilizes machine learning (ML) and artificial intelligence (AI) to deduce a purpose behind a user utterance. In brief, intent classification involves the categorization of keywords and/or phrases into predefined categories each related to a specific intent relevant to a specific knowledge domain. Examples of said predefined categories, and therefore intents, in the example knowledge domain of product manufacturing, include: product information; refund status; order status; replacement status; and address change.

In one or many embodiment(s) described herein, the domain state tracker (144) represents a computer program, or computer readable instructions, which when executed or invoked, perform(s) dialogue modeling entailing the tracking of dialogue state and/or context. To said extent, and at least within the production setting of the polite dialog service (104), the domain state tracker (144) includes functionality to: obtain intents/intent tags from the domain identifier (142); maintain dialogue modeling (described below) through interpretation of said intents/intent tags to produce a current dialogue state for each of one or more dialogues between any user(s) of, and the polite dialog agent (see e.g., 126, FIG. 1B) on, one or more client devices (see e.g., 102, FIGS. 1A & 1B); and provide said intents/intent tags, as well as the current dialogue state(s), to the action generator (148) for processing.

In one or many embodiment(s) described herein, dialogue modeling refers to the maintenance of a dialogue history for each of one or more dialogues. Any dialogue history, for a given dialogue, may include a record of what has been said to date in the given dialogue, such as the intents and entities identified in any previous user utterance(s). Dialogue modeling may also involve the correct interpretation of any context change(s) introduced by any user(s) within their respective dialogues before any immediate action(s) by the polite dialog agent/service has/have been taken. For example, during conversation, a user may first order a milkshake (submitted via a first user utterance), but may subsequently decide to order a coffee instead (submitted via a second user utterance). Through dialogue modeling, a recordation of said context shift is made so that an action or response appropriate to the new/current context is performed rather than the original/previous context.

In one or many embodiment(s) described herein, the information identifier (146) represents a computer program, or computer readable instructions, which when executed or invoked, perform(s) entity extraction entailing the identification of one or more entities provided in any text embedding(s). To said extent, and at least within the production setting of the polite dialog service (104), the information identifier (146) includes functionality to: obtain text embeddings from the embedding generator (140); process said text embeddings using entity extraction (described below) to produce entities (or entity tags thereof); and provide said entities/entity tags to the action generator (148) and domain knowledge base (150) for processing.

In one or many embodiment(s) described herein, entity extraction refers to a NLP technique that identifies/extracts one or more key elements (e.g., nouns) from text and classifies each of said key element(s) into predefined categories relevant to a specific knowledge domain. Continuing with the above-mentioned example knowledge domain of product manufacturing, examples of said key elements and their respective predefined categories include: “99123750” and order number; “John Smith” and customer name; “832-123-4567” and customer phone number; and “9999 9999 9999 9999 9999” and shipping tracking number.

In one or many embodiment(s) described herein, the action generator (148) represents a computer program, or computer readable instructions, which when executed or invoked, perform(s) next action deduction entailing the selection of appropriate task(s) and/or response(s) to pursue next in the conversation. To said extent, and at least within the production setting of the polite dialog service (104), the action generator (148) includes functionality to: obtain entities/entity tags and current dialogue state(s) from the domain state tracker (144), as well as entities/entity tags from the information identifier (146); process said entities/entity tags, current dialogue state(s), and entities/entity tags using next action deduction (described below) to produce actions (or action tags thereof); retrieve action relevant information (should said information be warranted by said actions/action tags) from the domain knowledge base (150); and provide said actions/action tags, as well as said action relevant information (if any), to the response generator (152) for processing.

In one or many embodiment(s) described herein, next action deduction refers to the use of ML and/or AI technique(s) (e.g., a transformer encoder-decoder model trained on dialogue histories reflecting dialogue state(s), as well as captured intents and entities) to decide next steps for the current dialogue state(s) of any dialogue(s). To facilitate said next steps decision, next action deduction may involve the maintenance of task records each describing information gathered thus far during a given dialogue. Any task record may be represented, for example, as a form, a frame, a template, or a graph, which may be referred to in order to determine what information has already been acquired and what information (if any) is still needed to ultimately arrive at the purpose or objective of the given dialogue. Continuing with the above-mentioned example knowledge domain of product manufacturing, examples of said actions/action tags include: “greet start” for projecting conversation opening greetings (e.g., “hello”); “greet end” for projecting conversation finishing greetings (e.g., “good-bye”); “verification” for attaining user confirmation of their intents; “inform” for providing any user requested content; and “request” for attaining additional context and/or information from the user.

In one or many embodiment(s) described herein, the domain knowledge base (150) represents a data repository configured to store any information subject to one or more knowledge domains and pertinent to one or more functionalities of the polite dialog service (104). Said information may include, but is not limited to: predefined key element categories (i.e., entity classifications) (e.g., “order number” under product manufacturing, “cuisine type” under food, etc.) and respective key element values (i.e., entities) (e.g., “99123750” under product manufacturing, “Italian” under food, etc.) related or relevant to any number of users; and predefined keyword/phrase categories (i.e., intents) (e.g., “order status” under product manufacturing, “restaurant address” under food, etc.) and respective keyword/phrase values (i.e., intent values) (e.g., “shipped” under product manufacturing, “1200 XYZ Street” under food, etc.) related or relevant to any number of supported contexts.

In one or many embodiment(s) described herein, the domain knowledge base (150) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, the response generator (152) represents a computer program, or computer readable instructions, which when executed or invoked, perform(s) natural language generation entailing formulation of polite, human-understandable responses. To said extent, and at least within the production setting of the polite dialog service (104), the response generator (152) includes functionality to: obtain actions/action tags, as well as any action relevant information (retrieved from the domain knowledge base (150)) from the action generator (148); translate said action/action tags and action relevant information (if any) using natural language generation (described below) to produce agent utterances (in text form); and transmit the agent utterance(s) to the appropriate client device(s) (102).

In one or many embodiment(s) described herein, natural language generation refers to a NLP component, driven by AI, that produces natural written (or spoken) language from structured and unstructured data. Specifically, through sentence aggregation, grammar structuring, and proper pronoun/adjective insertion, natural language generation converts data (understood by the polite dialog service (104)) into coherent, contextually relevant, and human-readable text. Continuing with the above-mentioned example knowledge domain of product manufacturing, an example natural written language response, generated from an intent directed to order status and an action directed to verification, may be: “I understand that you would like to know your order status. Is that correct?”

In one or many embodiment(s) described herein, the error controller (154) represents a computer program, or computer readable instructions, which when executed or invoked, refine(s) one or more other polite dialog service (104) subcomponents. To said extent, and at least within the production setting of the polite dialog service (104), the error controller (154) includes functionality to: recognize any error(s) in the respective output(s) of one or more other polite dialog service (104) subcomponents—e.g., the domain identifier (142), the domain state tracker (144), the information identifier (146), the action generator (148), and/or the response generator (152); and adjust any said other polite dialog service (104) subcomponent(s) based on said recognized error(s).

While FIG. 1C shows a configuration of components and/or subcomponents, other polite dialog service (104) configurations may be used without departing from the scope of the embodiments described herein.

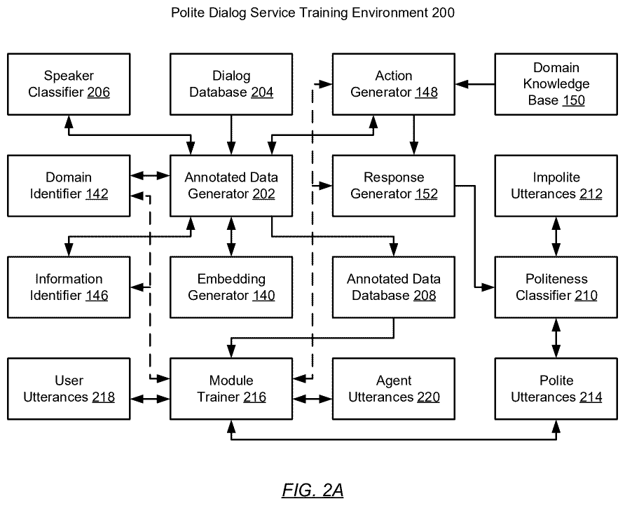

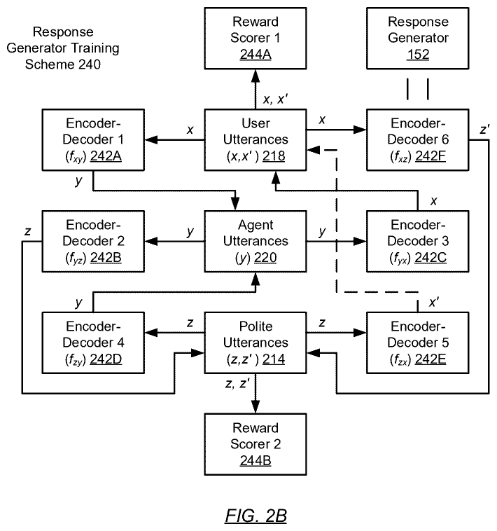

FIG. 2A shows a polite dialog service training environment in accordance with one or more embodiments described herein. The polite dialog service training environment (200) represents a pre-production (offline) setting wherein one or more modules/subcomponents of the polite dialog service (see e.g., 104, FIG. 1C) undergo development and/or optimization. The polite dialog service training environment (200) includes an annotated data generator (202), a dialog database (204), an embedding generator (140), a speaker classifier (206), a domain identifier (142), an information identifier (146), an action generator (148), a domain knowledge base (150), a response generator (152), an annotated data database (208), a politeness classifier (210), impolite utterances (212), polite utterances (214), a module trainer (216), user utterances (218), and agent utterances (220). Each of these polite dialog service training environment (200) subcomponents is described below.

In one or many embodiment(s) described herein, the annotated data generator (202) represents a computer program, or computer readable instructions, which when executed or invoked, produce(s) annotated datasets. Any (singular) annotated dataset relates to a given dialog sample and refers to a collection of annotated data tuples each representative of a given dialog sample sentence recited in the given dialog sample. Any dialog sample, in turn, refers to an example conversation conducted between a user and a polite dialog agent (see e.g., 126, FIG. 1B) in reference to a specific knowledge domain. Meanwhile, any dialog sample sentence refers to a collection of one or more words forming a syntactic unit, which expresses a statement, a question, a request, an exclamation, a command, etc. Furthermore, any annotated data tuple refers to an ordered list representation of a respective dialog sample sentence. Said ordered list representation may encompass a sequence of key-value pairs each capturing a feature of the respective dialog sample sentence.

Examples of said feature keys include: (a) ‘Speaker’-referring to either the user or the polite dialog agent as being the source communicator of the dialog sample sentence; (b) ‘Intent’-referring to the underlying purpose or objective expressed in the dialog sample sentence, which may be relevant to a specific knowledge domain; (c) ‘Entities’-referring to any key element(s) disclosed in the dialog sample sentence, which may be relevant to the ‘Intent’ and to the specific knowledge domain; and (d) ‘Action’-referring to a best next task or response that should be pursued by the polite dialog agent/service during the course of the conversation. Said feature keys, moreover, are not limited to the aforementioned specific examples.

Furthermore, in one or many embodiment(s) described herein, said feature value(s) for each key-value pair, in any annotated data tuple, may be populated using one or more tags (e.g., a speaker tag, an intent tag, at least one entity tag, or an action tag). Said tag(s) may be obtained/produced through processing of at least a dialog sample sentence embedding representative of a dialog sample sentence to which the annotated data tuple corresponds. More on said processing below with respect to the speaker classifier (206), the domain identifier (142), the information identifier (146), and the action generator (148).

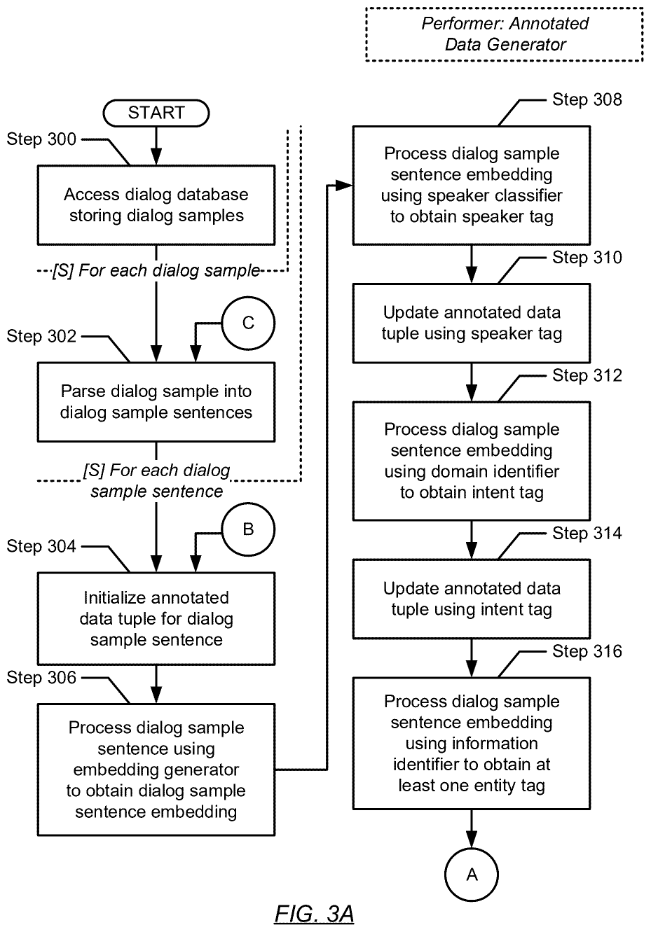

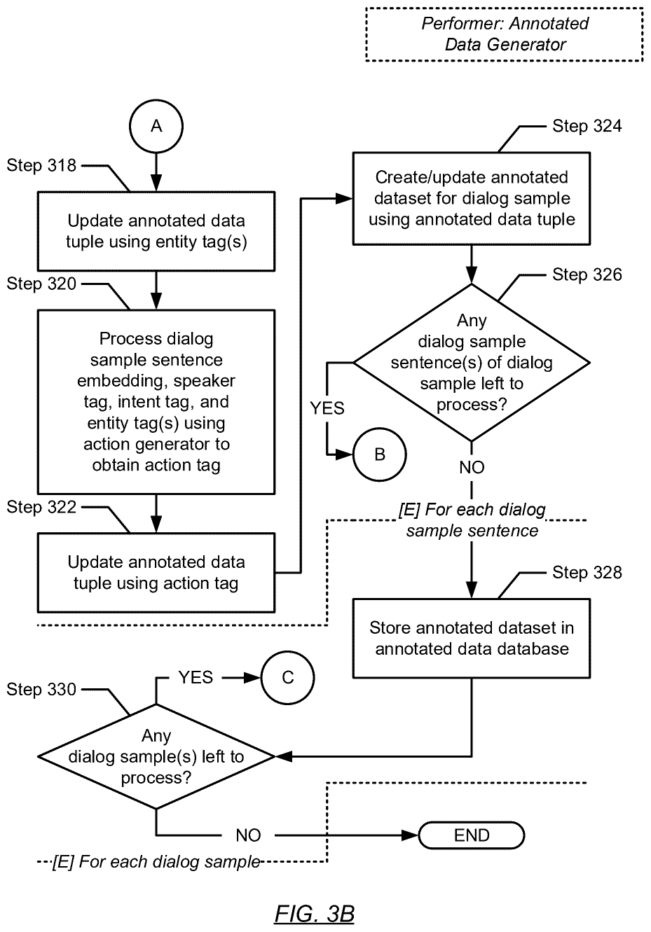

In one or many embodiment(s) described herein, and at least within the pre-production setting of the polite dialog service training environment (200), the annotated data generator (202) includes functionality to perform the method outlined and described below with respect to FIGS. 3A & 3B, which pertains to annotated data generation.

In one or many embodiment(s) described herein, the dialog database (204) represents a data repository configured to store various dialog samples respective to one or more knowledge domains supported by the polite dialog agent/service (see e.g., 126, FIG. 1B or 104, FIGS. 1A & 1C). Further, as mentioned above, any dialog sample refers to an example conversation conducted between a user and the polite dialog agent with respect to a specific knowledge domain.

In one or many embodiment(s) described herein, the dialog database (204) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, and as mentioned above with respect to FIG. 1C, the embedding generator (140) represents a computer program, or computer readable instructions, which when executed or invoked, perform(s) text vectorization entailing the translation of text sentences to numerical representations (or text embeddings) thereof. To said extent, and at least within the pre-production setting of the polite dialog service training environment (200), the embedding generator (140) includes functionality to: obtain dialog sample sentences, parsed from any given dialog sample, from the annotated data generator (202); process said dialog sample sentences via text vectorization to obtain/produce dialog sample sentence embeddings, respectively; and provide said dialog sample sentence embeddings back to the annotated data generator (202) for recordation and/or dissemination amongst one or more other polite dialog service training environment (200) subcomponents.

In one or many embodiment(s) described herein, the speaker classifier (206) represents a computer program, or computer readable instructions, which when executed or invoked, determine(s) the source communicator behind any utterance (or dialog sample sentence). To said extent, and at least within the pre-production setting of the polite dialog service training environment (200), the speaker classifier (206) includes functionality to: obtain dialog sample sentence embeddings from the annotated data generator (202); process said dialog sample sentence embeddings using a transformer based classification model to obtain/produce speaker tags, respectively, indicating the source communicator (e.g., user or polite dialog agent) per dialog sample sentence; and provide said speaker tags back to the annotated data generator (202) for recordation and/or dissemination amongst one or more other polite dialog service training environment (200) subcomponents.

In one or many embodiment(s) described herein, and as mentioned above with respect to FIG. 1C, the domain identifier (142) represents a computer program, or computer readable instructions, which when executed or invoked, perform(s) intent classification entailing the recognition of the intent(s) underlying any text embedding(s). To said extent, and at least within the pre-production setting of the polite dialog service training environment (200), the domain identifier (142) includes functionality to: obtain dialog sample sentence embeddings from the annotated data generator (202); process said dialog sample sentence embeddings via intent classification to obtain/produce intent tags, respectively, indicating the purpose or objective per dialog sample sentence; and provide said intent tags back to the annotated data generator (202) for recordation and/or dissemination amongst one or more other polite dialog service training environment (200) subcomponents.

In one or many embodiment(s) described herein, and as mentioned above with respect to FIG. 1C, the information identifier (146) represents a computer program, or computer readable instructions, which when executed or invoked, perform(s) entity extraction entailing the identification of one or more entities provided in any text embedding(s). To said extent, and at least within the pre-production setting of the polite dialog service training environment (200), the information identifier (146) includes functionality to: obtain dialog sample sentence embeddings from the annotated data generator (202); process said dialog sample sentence embeddings via entity extraction to obtain/produce sets of entity tags, respectively, indicating the key element(s) disclosed per dialog sample sentence; and provide said sets of entity tags back to the annotated data generator (202) for recordation and/or dissemination amongst one or more other polite dialog service training environment (200) subcomponents.

In one or many embodiment(s) described herein, and as mentioned above with respect to FIG. 1C, the action generator (148) represents a computer program, or computer readable instructions, which when executed or invoked, perform(s) next action deduction entailing the selection of appropriate response(s) to any user utterance(s), respectively. To said extent, and at least within the pre-production setting of the polite dialog service training environment (200), the action generator (148) includes functionality to: obtain dialog sample sentence embeddings, speaker tags, intent tags, and sets of entity tags, from the annotated data generator (202); process said dialog sample sentence embeddings, speaker tags, intent tags, and sets of entity tags via next action deduction to obtain/produce action tags, respectively, indicating a next task or response that should be pursued per dialog sample sentence; and provide said action tags back to the annotated data generator (202) for recordation.

In one or many embodiment(s) described herein, and at least within the pre-production setting of the polite dialog service training environment (200), the action generator (148) includes additional functionality to: retrieve any action relevant information (if pertinent to fulfilling any next task(s)/response(s)) from the domain knowledge base (150); and provide said action tag, as well as said action relevant information (if any), per dialog sample sentence to the response generator (152) for processing.

In one or many embodiment(s) described herein, and as mentioned above with respect to FIG. 1C, the domain knowledge base (150) represents a data repository configured to store any information subject to one or more knowledge domains and pertinent to one or more functionalities of the polite dialog agent/service. Said information may include, but is not limited to: predefined key element categories (i.e., entity classifications) (e.g., “order number” under product manufacturing, “cuisine type” under food, etc.) and respective key element values (i.e., entities) (e.g., “99123750” under product manufacturing, “Italian” under food, etc.) related or relevant to any number of users; and predefined keyword/phrase categories (i.e., intents) (e.g., “order status” under product manufacturing, “restaurant address” under food, etc.) and respective keyword/phrase values (i.e., intent values) (e.g., “shipped” under product manufacturing, “1200 XYZ Street” under food, etc.) related or relevant to any number of supported contexts.

In one or many embodiment(s) described herein, and as mentioned above with respect to FIG. 1C, the response generator (152) represents a computer program, or computer readable instructions, which when executed or invoked, perform(s) natural language generation entailing formulation of polite, human-understandable responses. To said extent, and at least within the pre-production setting of the polite dialog service training environment (200), the response generator (152) includes functionality to: obtain an action tag, as well as action relevant information (if any), per dialog sample sentence from the action generator (148); process said action tag and action relevant information (if any) via natural language generation to obtain/produce an unclassified utterance (i.e., an utterance not yet classified as being polite or impolite); and provide said unclassified utterance to the politeness classifier (210) for processing.

In one or many embodiment(s) described herein, the annotated data database (208) represents a data repository configured to store any annotated datasets (described above) created by the annotated data generator (202).

In one or many embodiment(s) described herein, the annotated data database (208) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

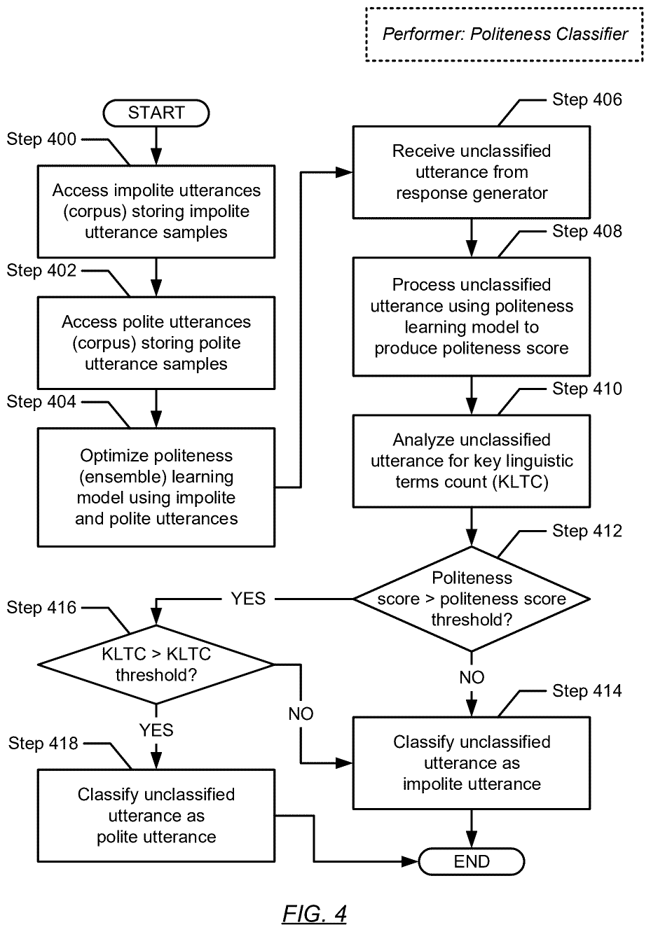

In one or many embodiment(s) described herein, the politeness classifier (210) represents a computer program, or computer readable instructions, which when executed or invoked, measure(s) a politeness expressed in utterances and, subsequently, deem(s) said utterances as polite or impolite based on said measurement(s). To said extent, and at least within the pre-production setting of the polite dialog service training environment (200), the politeness classifier (210) includes functionality to perform the method outlined and described below with respect to FIG. 4, which pertains to unclassified utterance classification.

In one or many embodiment(s) described herein, the impolite utterances (212) represents a corpus (or a data repository) configured to store various user and/or agent utterances classified as being impolite. Any impolite utterance may be classified as such based on a failure to exceed a combination of thresholds directed to measuring politeness (see e.g., FIG. 4).

In one or many embodiment(s) described herein, the (corpus/repository of) impolite utterances (212) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, the polite utterances (214) represents a corpus or a data repository configured to store various user and/or agent utterances classified as being polite. Any polite utterance may be classified as such based on a success to exceed a combination of thresholds directed to measuring politeness (see e.g., FIG. 4).

In one or many embodiment(s) described herein, the (corpus/repository of) polite utterances (214) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

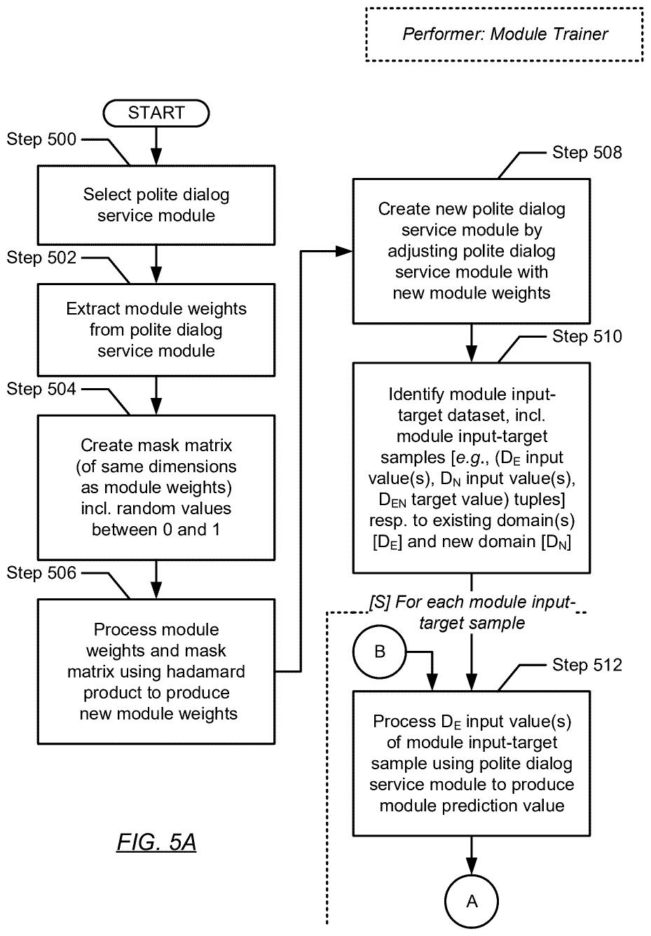

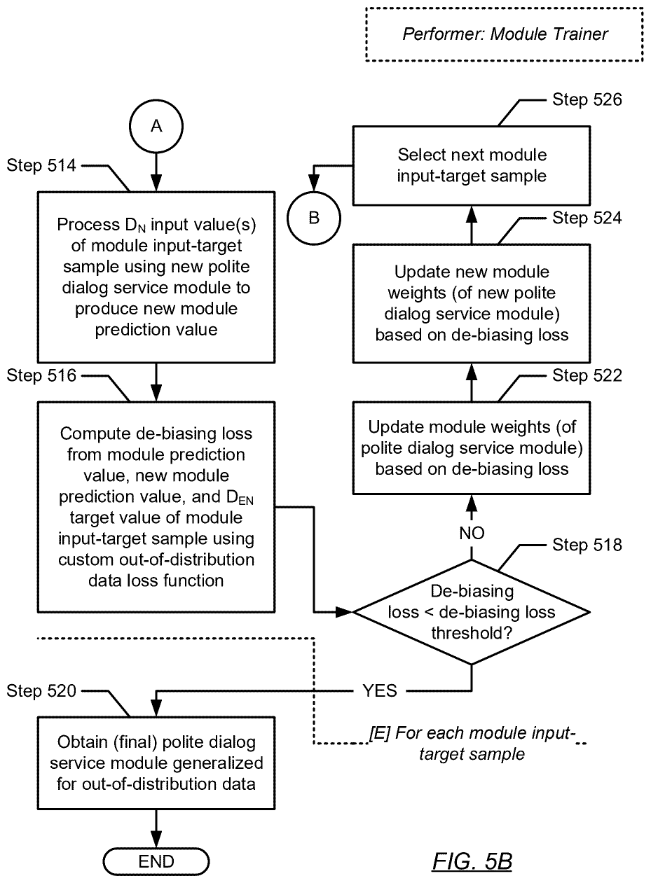

In one or many embodiment(s) described herein, the module trainer (216) represents a computer program, or computer readable instructions, which when executed or invoked, perform(s) out-of-distribution generalization entailing the optimization and de-biasing of various polite dialog service subcomponents (also referred to herein as modules) across multiple knowledge domains. To said extent, and at least within the pre-production setting of the polite dialog service training environment (200), the module trainer (216) includes functionality to perform the method outlined and described below with respect to FIGS. 5A & 5B, which pertains to polite dialog service module generalization.

In one or many embodiment(s) described herein, the user utterances (218) represents a corpus or a data repository configured to store various utterances sourced from one or more users, and with respect to one or more knowledge domains. Further, said user utterances (218) include both polite and impolite examples thereof.

In one or many embodiment(s) described herein, the (corpus/repository of) user utterances (218) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, the agent utterances (220) represents a corpus or a data repository configured to store various utterances generated by (and thus sourced from) the polite dialog service, and with respect to one or more knowledge domains. Further, said agent utterances (220) include both polite and impolite examples thereof.

In one or many embodiment(s) described herein, the (corpus/repository of) agent utterances (220) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

While FIG. 2A shows a configuration of components and/or subcomponents, other polite dialog service training environment (200) configurations may be used without departing from the scope of the embodiments described herein.

FIG. 2B shows a response generator training scheme in accordance with one or more embodiments described herein. The response generator training scheme (240) represents an optimization pipeline, or a series of data processing elements, directed to training the response generator (see e.g., 152, FIGS. 1C & 2A) and minimizing a de-biasing loss (described below) (see e.g., FIGS. 5A & 5B), at least in part, responsible for maximizing a performance/accuracy of said response generator (152).

In one or many embodiment(s) described herein, the response generator training scheme (240) includes, and thus employs, multiple encoder-decoders (242A-242F). Any encoder-decoder (242A-242F) represents a neural network architecture used for sequence-to-sequence learning, and includes: an encoder configured to process an input sequence (e.g., an input utterance) to produce a context vector (i.e., an encoded representation of the input sequence capturing contextual information relating the word(s) therein); and a decoder configured to process said context vector to produce an output sequence (e.g., an output utterance). Any encoder-decoder (242A-242F), moreover, may be denoted as a function (ƒᵢₒ), where the first subscript (i) references the input utterance processed, while the second subscript (o) references the output utterance generated, thereby.

In one or many embodiment(s) described herein, the response generator training scheme (240) includes, and thus employs, a pair of reward scorers (244A, 244B). Any reward scorer (244A, 244B) represents a neural network architecture trained to act as a surrogate for human feedback, with the objective of assessing an alignment between output utterances (generated by one or more encoder-decoders (242A-242F)) and human preferences (e.g., sufficient politeness, etc.). To said extent, Reward Scorer 1 (244A) accepts and processes a user utterance (218) sample pair (including an existing user utterance sample (x) and a new user utterance sample (x′)) to produce a first scalar reward score quantifying a similarity between said user utterance (218) sample pair. Meanwhile, Reward Scorer 2 (244B) accepts and processes a polite utterance (214) sample pair (including an existing polite utterance sample (z) and a new polite utterance sample (z′)) to produce a second scalar reward score quantifying a similarity between said polite utterance (214) sample pair.

In one or many embodiment(s) described herein, the response generator training scheme (240) includes, and thus employs, multiple corpuses or data repositories. Said corpuses/repositories include: (a) the user utterances (218) (described above-see e.g., FIG. 2A) including a combination of existing user utterance samples (x) sourced prior to the response generator training scheme (240) and new user utterance samples (x′) generated during the response generator training scheme (240); (b) the agent utterances (220) (described above-see e.g., FIG. 2A) including agent utterance samples (y) generated during the response generator training scheme (240); and (c) the polite utterances (214) (described above-see e.g., FIG. 2A) including a combination of existing polite utterance samples (z) sourced prior to the response generator training scheme (240) and new polite utterance samples (z′) generated during the response generator training scheme (240).

With the above-mentioned in mind, the response generator training scheme (240) includes the following sequence of steps:
1. Encoder-Decoder 1 (ƒ_{ry}) (242A) processes a first user utterance sample (x₁) from the user utterances (218) to produce a first agent utterance sample (y₁), which is subsequently stored within the agent utterances (220)
2. Encoder-Decoder 2 (ƒ_{yz}) (242B) processes the first agent utterance sample (y₁) stored within the agent utterances (220) to produce a first polite utterance sample (z₁), which is subsequently stored within the polite utterances (214)
3. Encoder-Decoder 4 (ƒ_{zy}) (242D) processes the first polite utterance sample (z₁) stored within the polite utterances (214) to produce a second agent utterance sample (y₂), which is subsequently stored within the agent utterances (220)
4. Encoder-Decoder 3 (ƒ_{yx}) (242C) processes the second agent utterance sample (y₂) stored within the agent utterances (220) to produce a third user utterance sample (x₃), which is subsequently stored within the user utterances (218)
5. Encoder-Decoder 5 (ƒ_{zx}) (242E) processes the first polite utterance sample (z₁) stored within the polite utterances (214) to produce a fourth user utterance sample (x₄=x′), which is subsequently stored within the user utterances (218)
6. Reward Scorer 1 (244A) processes the first user utterance sample (x₁) and the fourth user utterance sample (x′) stored within the user utterances (218) to produce a first reward score (s₁)
7. Encoder-Decoder 6 (ƒ_{xz}) (242F) processes the third user utterance sample (x₃) stored within the user utterances (218) to produce a second polite utterance sample (z₂=z′)
8. Reward Scorer 2 (244B) processes the first polite utterance sample (z₁) and the second polite utterance sample (z′) stored within the polite utterances (214) to produce a second reward score (2)
9. A first combined loss (Loss₁₃) respective to Encoder-Decoder 1 (ƒ_{ry}) (242A) and Encoder-Decoder 3 (ƒ_{yx}) (242C) is computed using the following combined loss function [where P ( ) refers to probability]:

$${Loss}_{13} = - log P ( y \vert x ; {f}_{xy} ) - log P ( x \vert y ; {f}_{yx} )$$

10. A second combined loss (Loss₂₄) respective to Encoder-Decoder 2 (ƒ_{yz}) (242B) and Encoder-Decoder 4 (ƒ=x) (242D) is computed using the following combined loss function [where P ( ) refers to probability]:

$${Loss}_{24} = - log P ( z \vert y ; {f}_{yz} ) - log P ( y \vert z ; {f}_{zy} )$$

11. A third combined loss (Loss₅₆) respective to Encoder-Decoder 5 (ƒer) (242E) and Encoder-Decoder 6 (ƒ_{xz}) (242F) is computed using the following combined loss function [where P ( ) refers to probability]:

$${Loss}_{56} = - log P ( z \vert {x}^{′} ; {f}_{xz} ) - log P ( x \vert z {f}_{z x} )$$

12. A total loss (Loss_{T}) aggregating the first combined loss (Loss₁₃), the second combined loss (Loss₂₄), the third combined loss (Loss₅₆), the first reward score (s₁), and the second reward score (s₂) is computed:

$${Loss}_{T} ∼ [ {Loss}_{13} + {Loss}_{24} + {Loss}_{56} + {s}_{1} + {s}_{2} ]$$

13. A determination is made based on the total loss, which results in either Encoder-Decoder 6 (ƒ_{xz}) (242F) being integrated as the response generator (152) within the production setting of the polite dialog service (see e.g., 104, FIG. 1C) or another iteration of the response generator training scheme (240) is performed:

$$If {Loss}_{T} < {Loss}_{T} Threshold \to Resp . Gen . = {f}_{xz} \\ Else \to Repeat Steps 1 through 12$$

FIGS. 3A and 3B show a flowchart outlining a method for annotated data generation in accordance with one or more embodiments described herein. The various steps outlined below may be performed by the annotated data generator operating within the polite dialog service training environment (see e.g., FIG. 2A). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, a dialog database is accessed. In one or many embodiment(s) described herein, the dialog database represents a data repository configured to store any number of dialog samples each in text form (e.g., a transcript). Any dialog sample, further, refers to an example conversation conducted between a user and a polite dialog agent (see e.g., 126, FIG. 1B) in reference to a specific knowledge domain.

Hereinafter, a subset of the remaining steps (i.e., Steps 302, 304, 306, 308, 310, 312, 314, 316, 318, 320, 322, 324, 326, 328, and 330) may be performed, iteratively as a whole, for each dialog sample stored in the dialog database (accessed in Step 300). For example, a first iteration of the indicated remaining steps may be performed with respect to a first dialog sample selected from the dialog database; thereafter, a second iteration of the indicated remaining steps may be performed with respect to a second dialog sample selected from the dialog database; and so forth, including a last iteration of the indicated remaining steps that may be performed with respect to a last dialog sample selected from the dialog database.

In Step 302, the (selected) dialog sample is parsed into multiple dialog sample sentences. In one or many embodiment(s) described herein, any dialog sample sentence refers to a collection of one or more words forming a syntactic unit, which expresses a statement, a question, a request, an exclamation, a command, etc.

Hereinafter, a subset of the remaining steps (i.e., Steps 302, 304, 306, 308, 310, 312, 314, 316, 318, 320, 322, 324, and 326) may be performed, iteratively as a whole, for each dialog sample sentence forming the dialog sample (parsed in Step 302). For example, a first iteration of the indicated remaining steps may be performed with respect to a first dialog sample sentence forming the dialog sample; thereafter, a second iteration of the indicated remaining steps may be performed with respect to a second dialog sample sentence forming the dialog sample; and so forth, including a last iteration of the indicated remaining steps that may be performed with respect to a last dialog sample sentence forming the dialog sample.

A non-limiting example of a dialog sample sentence is presented below, which pertains to the product manufacturing knowledge domain:

“Accept our sincere apologies for having missed the estimated ship date for your order number 123456789, let me check its status for you.”

In Step 304, an annotated data tuple, for the dialog sample sentence, is initialized. In one or many embodiment(s) described herein, the annotated data tuple refers to an ordered list representation of the dialog sample sentence, and encompasses a sequence of key-value pairs each capturing a feature of the dialog sample sentence.

A non-limiting example of an initialized annotated data tuple is presented below, which reflects a number of feature keys as well as blanks for their corresponding feature values:

$$\{ ‘ Speaker ’ : ‘ ’ , ‘ Intent ’ : ‘ ’ , ‘ Entities ’ : \{ ‘ ’ \} , ‘ Action ’ : ‘ ’ \}$$

In Step 306, the dialog sample sentence is processed using an embedding generator (see e.g., 140, FIGS. 1C & 2A). In one or many embodiment(s) described herein, said processing may entail text vectorization, or the conversion of text into a numerical representation (i.e., embedding) thereof. Further, as a result of said processing, a dialog sample sentence embedding is obtained.

In Step 308, the dialog sample sentence embedding (obtained in Step 306) is processed using a speaker classifier (see e.g., 206, FIG. 2A). In one or many embodiment(s) described herein, said processing may entail determining the source communicator behind the dialog sample sentence using a transformer based classification model. Further, as a result of said processing, a speaker tag is obtained/produced, which indicates said source communicator as a user or a polite dialog agent.

In Step 310, the annotated data tuple (initialized in Step 304) is updated using the speaker tag (obtained in Step 308). In one or many embodiment(s) described herein, said updating of the annotated data tuple may entail replacing the blank feature value, corresponding to the ‘Speaker’ feature key, with the speaker tag.

A non-limiting example of the updated annotated data tuple is presented below, which reflects an ‘Agent’ speaker tag corresponding to the ‘Speaker’ feature key, thereby identifying a polite dialog agent as the source communicator behind the above-presented example dialog sample sentence:

$$\{ ‘ Speaker ’ : ‘ Agent ’ , ‘ Intent ’ : ‘ ’ , ‘ Entities ’ : \{ ‘ ’ \} , ‘ Action ’ : ‘ ’ \}$$

In Step 312, the dialog sample sentence embedding (obtained in Step 306) is processed using a domain identifier (see e.g., 142, FIGS. 1C & 2A). In one or many embodiment(s) described herein, said processing may entail intent classification, or the recognition of any purpose or objective underlying the dialog sample sentence. Further, as a result of said processing, an intent tag is obtained/produced, which indicates one of many intents supported by the polite dialog service for the specific knowledge domain.

In Step 314, the annotated data tuple (updated in Step 310) is updated using the intent tag (obtained in Step 312). In one or many embodiment(s) described herein, said updating of the annotated data tuple may entail replacing the blank feature value, corresponding to the ‘Intent’ feature key, with the intent tag.

A non-limiting example of the updated annotated data tuple is presented below, which reflects an ‘Order Status’ intent tag corresponding to the ‘Intent’ feature key, thereby recognizing the status of a product order as the purpose/objective behind the above-presented example dialog sample sentence:

$$\{ ‘ Speaker ’ : ‘ Agent ’ , ‘ Intent ’ : ‘ Order Status ’ , ‘ Entities ’ : \{ ‘ ’ \} , ‘ Action ’ : ‘ ’ \}$$

In Step 316, the dialog sample sentence embedding (obtained in Step 306) is processed using an information identifier (see e.g., 146, FIGS. 1C & 2A). In one or many embodiment(s) described herein, said processing may entail entity extraction, or the identification of one or more key elements disclosed in the dialog sample sentence. Further, as a result of said processing, at least one entity tag is/are obtained/produced, which identifies any information pertinent to the recognized intent, as well as relevant to the specific knowledge domain.

Turning to FIG. 3B, in Step 318, the annotated data tuple (updated in Step 314) is updated using the entity tag(s) (obtained in Step 316). In one or many embodiment(s) described herein, said updating of the annotated data tuple may entail replacing the blank feature value, corresponding to the ‘Entities’ feature key, with the at least one entity tag.

A non-limiting example of the updated annotated data tuple is presented below, which reflects an ‘Order Number’: ‘123456789’ entity tag corresponding to the ‘Entities’ feature key, thereby identifying the disclosed order number as a key element expressed in the above-presented example dialog sample sentence:

{ ‘Speaker’ : ‘Agent’, ‘Intent’ : ‘Order Status', ‘Entities' : {‘Order
Number’ : ‘123456789’}, ‘Action’ : ‘’ }

In Step 320, the dialog sample sentence embedding (obtained in Step 306), the speaker tag (obtained in Step 308), the intent tag (obtained in Step 312), and the entity tag(s) (obtained in Step 316) are processed using an action generator (see e.g., 148, FIGS. 1C & 2A). In one or many embodiment(s) described herein, said processing may entail next action deduction, or the determination of a next task or response that should be pursued. Further, as a result of said processing, an action tag is obtained/produced, which indicates said determined next task/response.

In Step 322, the annotated data tuple (updated in Step 318) is updated using the action tag (obtained in Step 320). In one or many embodiment(s) described herein, said updating of the annotated data tuple may entail replacing the blank feature value, corresponding to the ‘Action’ feature key, with the action tag.

A non-limiting example of the updated annotated data tuple is presented below, which reflects an ‘Inform’ action tag corresponding to the ‘Action’ feature key, thereby indicating that a best next task/response would be to provide (or inform) the user with a current order status of their product order:

{ ‘Speaker’ : ‘Agent’, ‘Intent’ : ‘Order Status', ‘Entities' : {‘Order
Number’ : ‘123456789’}, ‘Action’ : ‘Inform’ }

In Step 324, an annotated dataset, for the dialog sample, is either created or updated using the annotated data tuple (updated in Step 322). In one or many embodiment(s) described herein, said annotated dataset refers to a collection of annotated data tuples, including the annotated data tuple.

In Step 326, a determination is made as to whether any dialog sample sentence(s) (obtained via parsing of the dialog sample in Step 302, which had been selected via accessing of the dialog database in Step 300) has/have yet to be processed. In one or many embodiment(s) described herein, if it is determined that all dialog sample sentences, of the dialog sample, have undergone processing, then the method proceeds to Step 328. On the other hand, in one or many other embodiment(s) described herein, if it is alternatively determined that at least one dialog sample sentence, of the dialog sample, has not undergone processing, then the method alternatively proceeds to Step 304, where a (new) annotated data tuple, for a next dialog sample sentence of said at least one dialog sample sentence, is initialized.

In Step 328, following the determination (made in Step 326) that all dialog sample sentences, of the dialog sample, have undergone processing, the annotated dataset (created/updated in Step 324) is stored in an annotated data database (see e.g., 208, FIG. 2A).

In Step 330, a determination is made as to whether any dialog sample(s) (selected via accessing of the dialog database in Step 300) has/have yet to be processed. In one or many embodiment(s) described herein, if it is determined that all dialog samples have undergone processing, then the method ends. On the other hand, in one or many other embodiment(s) described herein, if it is alternatively determined that at least one dialog sample has not undergone processing, then the method alternatively proceeds to Step 302, where a next selected dialog sample, of said at least one dialog sample, is parsed.

FIG. 4 shows a flowchart outlining a method for unclassified utterance classification in accordance with one or more embodiments described herein. The various steps outlined below may be performed by the politeness classifier operating within the polite dialog service training environment (see e.g., FIG. 2A). Further, while the various steps in the flowchart are presented and described sequentially, one of ordinary skill will appreciate that some or all steps may be executed in different orders, may be combined or omitted, and some or all steps may be executed in parallel.

Turning to FIG. 4, in Step 400, a corpus of impolite utterances (see e.g., 212, FIG. 2A) is accessed. In one or many embodiment(s) described herein, said impolite utterances include various user and/or agent utterances that have been classified as being impolite.

In Step 402, a corpus of polite utterances (see e.g., 214, FIG. 2A) is accessed. In one or many embodiment(s) described herein, said polite utterances include various user and/or agent utterances that have been classified as being polite.

In Step 404, a politeness learning model is optimized using the corpus of impolite utterances (accessed in Step 400) and the corpus of polite utterances (accessed in Step 402). In one or many embodiment(s) described herein, said politeness learning model may be an ensemble transformer-based model, and may be configured to produce a politeness score based on a distribution of the polite and impolite utterances. Said politeness score (i.e., output of politeness learning model), in turn, may refer to a numerical value measuring a similarity of an input utterance (i.e., input of the politeness learning model) to the corpus of polite utterances.

In Step 406, an unclassified utterance is received from a response generator (see e.g., 152, FIGS. 1C & 2A). In one or many embodiment(s) described herein, said unclassified utterance refers to an agent utterance (produced by the response generator) yet to be classified as being either polite or impolite.

In Step 408, the unclassified utterance (received in Step 406 is processed using the politeness learning model (optimized in Step 404). In one or many embodiment(s) described herein, said processing produces a politeness score (described above) for the unclassified utterance.

In Step 410, the unclassified utterance (received in Step 406) is analyzed using part—of speech (POS) tagging. In one or many embodiment(s) described herein, POS tagging refers to a linguistic activity in NLP wherein each word in a given text (e.g., the unclassified utterance) is assigned to a grammatical category or part of speech—e.g., an adverb, an adjective, a noun, a verb, a pronoun, a determiner, a preposition, etc. Further, as a result of said analysis, a key linguistic terms count is obtained/produced. Said key linguistic terms count, in turn, refers to a numerical value indicating a total number of words, in the unclassified utterance, assigned to certain grammatical categories (e.g., adjectives, pronouns, etc.) predetermined to be associated with politeness.

In Step 412, a determination is made as to whether the politeness score (produced in Step 408) exceeds a politeness score threshold. In one or many embodiment(s) described herein, if it is determined that the politeness score is less than or equal to said politeness score threshold, then the method proceeds to Step 414. On the other hand, in one or many other embodiment(s) described herein, if it is alternatively determined that the politeness score is greater than said politeness score threshold, then the method alternatively proceeds to Step 416.

In Step 414, following the determination (made in Step 412) that the politeness score (produced in Step 408) equals or falls below a politeness score threshold, the unclassified utterance (received in Step 406) is classified as polite. Accordingly, in one or many embodiment(s) described herein, the unclassified utterance is labeled, and thus, becomes an impolite utterance. Thereafter, said impolite utterance may be stored in the corpus of impolite utterances (accessed in Step 404) to serve as another sample of said corpus for future unclassified utterance classifications.

In Step 416, following the alternate determination (made in Step 412) that the politeness score (produced in Step 408) exceeds a politeness score threshold, a determination is made as to whether the key linguistic terms count (obtained in Step 410) exceeds a key linguistic terms count threshold. In one or many embodiment(s) described herein, if it is determined that the key linguistic terms count is greater than said key linguistic terms count threshold, then the method proceeds to Step 418. On the other hand, in one or many other embodiment(s) described herein, if it is alternatively determined that the key linguistic terms count is less than or equal to said key linguistic terms count threshold, then the method proceeds to Step 414 (described above).

In Step 418, following the determination (made in Step 416) that the key linguistic terms count (obtained in Step 410) exceeds a key linguistic terms count threshold, the unclassified utterance (received in Step 406 is classified as polite. Accordingly, in one or many embodiment(s) described herein, the unclassified utterance is labeled, and thus becomes, a polite utterance. Thereafter, said polite utterance may be stored in the corpus of polite utterances (accessed in Step 404) to serve as another sample of said corpus for future unclassified utterance classifications.

FIGS. 5A and 5B show a flowchart outlining a method for polite dialog service module generalization in accordance with one or more embodiments described herein. The various steps outlined below may be performed by the module trainer operating within the polite dialog service training environment (see e.g., FIG. 2A). Further, while the various steps in the flowchart are presented and described sequentially, one of ordinary skill will appreciate that some or all steps may be executed in different orders, may be combined or omitted, and some or all steps may be executed in parallel.

Turning to FIG. 5A, in Step 500, a polite dialog service module is selected. In one or many embodiment(s) described herein, said polite dialog service module may be one of the following polite dialog service subcomponents: the domain identifier (see e.g., 142, FIGS. 1C & 2A), the information identifier (see e.g., 146, FIGS. 1C & 2A), the action generator (see e.g., 148, FIGS. 1C & 2A), or the response generator (see e.g., 152, FIGS. 1C & 2A).

In Step 502, module weights are extracted from the polite dialog service module (selected in Step 500). In one or many embodiment(s) described herein, said module weights may pertain to one or more multi-layer neural networks, at least in part, implementing the polite dialog service module. Further, for each multi-layer neural network, there may be two or more layers of neurons, including an input layer, an output layer, and zero or more hidden layers. Between each pair of consecutive layers, a weights matrix [R×C] (where R is the number of neurons forming a previous layer, and C is the number of neurons forming a next layer, of the pair of consecutive layers) may be maintained, with matrix elements (rϵR, cϵC) reflecting a connection strength between a neuron r of said previous layer and a neuron c of said next layer. Said module weights, accordingly, refers to a collection of one or more weights matrices for the polite dialog service module, which depends on the number of multi-layer neural networks and the structural architecture of each multi-layer neural network thereof.

In Step 504, one or more mask matrices is/are created. In one or many embodiment(s) described herein, each mask matrix may correspond to a given weights matrix of the module weights (extracted in Step 502) and, accordingly, may have the same dimensions as the dimensions of said given weights matrix. Further, each matrix element, of any mask matrix, may reflect a random numerical value between, and including, zero (0) and one (1).

In Step 506, the module weights (extracted in Step 502) and the mask matrix/matrices (created in Step 504) are each, respectively, processed using a Hadamard product. In one or many embodiment(s) described herein, said Hadamard product refers to a binary (or element-wise) operation that takes two matrices {M₁=[R₁×C₁] with matrix elements (r₁ϵR₁, c₁ϵC₁); M₂=[R₂×C₂] with matrix elements (r₂ϵR₂, c₂ϵC₂), where R₁=R₂ and C₁=C₂} of the same dimensions and returns a matrix {M_{HP}=[R_{HP}×C_{HP}] with matrix elements (r₁ϵR₁·r₂ϵR₂, c₁ϵC₁·c₂ϵC₂), where R_{HP}=R₁=R₂ and C_{HP}=C₁=C₂} of the multiplied corresponding matrix elements. Further, as a result of said processing, new module weights, encompassing one or more new weights matrices, are produced.

In Step 508, a new polite dialog service module is created. In one or many embodiment(s) described herein, said new polite dialog service module represents a clone (i.e., have the same structural architecture) of the polite dialog service module (selected in Step 500) with one exception. Said exception is that the new polite dialog service module may be characterized via integration of the new module weights (produced in Step 506) therein rather than the module weights (extracted in Step 502) of the polite dialog service module.

In Step 510, a module input-target dataset is identified from amongst a plethora of annotated data tuples stored in the annotated data database (see e.g., 208, FIG. 2A). In one or many embodiment(s) described herein, said module input-target dataset represents a collection of labeled data pertinent to model training via supervised learning. Said module input-target data, further, includes multiple module input-target samples each referring to a single labeled datum of the labeled data. Any module input-target sample includes: (a) one or more input values pertaining to any existing knowledge domain(s) for which the polite dialog service module (selected in Step 500) has already been generalized/optimized; (b) one or more input values pertaining to a new knowledge domain for which said polite dialog service module has not yet been generalized/optimized; and (c) one or more target (output) values common amongst the existing and new knowledge domains.

In one or many embodiment(s) described herein, any module input-target sample, of the module input-target dataset, reflects values relevant to the polite dialog service module (selected in Step 500). For example, if the polite dialog service module is the domain identifier (see e.g., 142, FIGS. 1C & 2A), then: (a) the input value, pertaining to the existing knowledge domain(s), includes a first text embedding representative of a first utterance; (b) the input value, pertaining to the new knowledge domain, includes a second text embedding representative of a second utterance; and (c) the target value, common amongst the existing and new knowledge domains, includes an intent tag reflecting the correct output of the domain identifier given the first text embedding and/or the second text embedding.

By way of another example, if the polite dialog service module is the action generator (see e.g., 148, FIGS. 1C & 2A), then: (a) the input values, pertaining to the existing knowledge domain(s), include: a third text embedding representative of a third utterance, a first speaker tag identifying the source communicator of said third utterance, a second intent tag recognizing a first purpose/objective behind said third utterance, and at least one first entity tag respectively identifying at least one first key element disclosed in said third utterance; (b) the input values, pertaining to the new knowledge domain, include: a fourth text embedding representative of a fourth utterance, a second speaker tag identifying the source communicator of said fourth utterance, a third intent tag recognizing a second purpose/objective behind said fourth utterance, and at least one second entity tag respectively identifying at least one second key element disclosed in said fourth utterance; and (c) the target value, common amongst the existing and new knowledge domains, includes an action tag reflecting the correct output of the action generator given the first set of input values (i.e., third text embedding, first speaker tag, second intent tag, and at least one first entity tag) and/or the second set of input values (i.e., fourth text embedding, second speaker tag, third intent tag, and at least one second entity tag).

Hereinafter, a subset of the remaining steps (i.e., Steps 512, 514, 516, 518, 520, 522, 524, and 526) may be performed, iteratively as a whole, for each module input-target sample in the module input-target dataset (identified in Step 510). For example, a first iteration of the indicated remaining steps may be performed with respect to a first module input-target sample of the module input-target dataset; thereafter, a second iteration of the indicated remaining steps may be performed with respect to a second module input-target sample of the module input-target dataset; and so forth, including a last iteration of the indicated remaining steps that may be performed with respect to a last module input-target sample of the module input-target dataset.

In Step 512, the input value(s), of the module input-target sample and pertaining to the existing knowledge domain(s), is/are processed using the polite dialog service module (selected in Step 500). In one or many embodiment(s) described herein, said processing, at least in part, may entail the propagation of said input value(s) through the multi-layer neural network(s) (characterized by the module weights (extracted in Step 502)) of said polite dialog service module. Further, as a result of said processing, one or more module prediction values is/are obtained/produced. Said module prediction value(s) refer(s) to the generated (output) value(s) provided by said polite dialog service module given said input value(s) pertaining to the existing knowledge domain(s).

Turning to FIG. 5B, in Step 514, the input value(s), of the module input-target sample and pertaining to the new knowledge domain, is/are processed using the new polite dialog service module (created in Step 508). In one or many embodiment(s) described herein, said processing, at least in part, may entail the propagation of said input value(s) through the multi-layer neural network(s) (characterized by the new module weights (produced in Step 506)) of said new polite dialog service module. Further, as a result of said processing, one or more new module prediction values is/are obtained/produced. Said new module prediction value(s) refer(s) to the generated (output) value(s) provided by said new polite dialog service module given said input value(s) pertaining to the new knowledge domain.

In Step 516, a de-biasing loss is computed. In one or many embodiment(s) described herein, the de-biasing loss (LOSSDB) refers to a quantification of the differences between the module prediction value(s) (PM) (produced in Step 512), the new module prediction value(s) (PNM) (produced in Step 514), and the target value(s) (T) (commonly pertaining to the existing and new knowledge domains) of the module input-target sample. Computation of said de-biasing loss, furthermore, may employ the following custom out-of-distribution data loss function:

$${Loss}_{DB} = - T \cdot Log Softmax ( log {P}_{M} + log {P}_{NM} )$$

In Step 518, a determination is made as to whether the de-biasing loss (computed in Step 516) falls below a de-biasing loss threshold. That is, as the de-biasing loss quantifies the difference between the generated and correct outputs (given the provided inputs) for the module input-target sample, the minimization of said difference, and thus, said de-biasing loss equates to the higher performance/accuracy, and therefore, the optimization of the polite dialog service module. To said extent, in one or many embodiment(s) described herein, if it is determined that the de-biasing loss is less than the de-biasing loss threshold (i.e., minimized to within an appropriate degree), then the method proceeds to Step 520. On the other hand, in one or many other embodiment(s) described herein, if it is alternatively determined that the de-biasing loss is greater than or equal to the de-biasing loss threshold (i.e., not minimized to within the appropriate degree), then the method alternatively proceeds to Step 522.

In Step 520, following the determination (made in Step 518) that the de-biasing loss (computed in Step 516) falls below a de-biasing loss threshold, a final polite dialog service module is obtained. In one or many embodiment(s) described herein, said final polite dialog service module represents the polite dialog service module (selected in Step 500) now optimized or generalized for the existing knowledge domain(s) as well as the new knowledge domain. Further, said final polite dialog service module, hereinafter, may be integrated into the production setting of the polite dialog service (see e.g., 104, FIG. 1C) for use in real-world scenarios.

In Step 522, following the alternate determination (made in Step 518) that the de-biasing loss (computed in Step 516) equals or exceeds a de-biasing loss threshold, the module weights (extracted in Step 502) are updated based on the de-biasing loss. In one or many embodiment(s) described herein, said updating may employ backpropagation, or a well-known method for the estimation of loss function (e.g., de-biasing loss) gradients with respect to each neural network parameter (e.g., module weights). Once said gradients are computed, a weight update rule, such as gradient descent, may be applied which updates said each parameter in a direction that minimizes said loss function. Further, as a result of said updating, an adjusted polite dialog service module is obtained/produced.

In Step 524, the new module weights, of the new polite dialog service module (created in Step 508), are updated based on the de-biasing loss (computed in Step 516). In one or many embodiment(s) described herein, said updating may employ backpropagation and a weight update rule (described above). Further, as a result of said updating, an adjusted new polite dialog service module is obtained/produced.

In Step 526, a next module input-target sample, in the module input-target dataset (identified in Step 510), is selected. Hereinafter, the method proceeds to Step 512, where the input value(s), of said next module input-target sample and pertaining to the existing knowledge domain(s), is/are processed using the adjusted polite dialog service module (obtained/produced in Step 522).

FIG. 6 shows a computing system in accordance with one or more embodiments described herein. The computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one or many embodiment(s) described herein, the computer processor(s) (602) may be an integrated circuit for processing instructions. For example, the computer processor(s) may be one or more cores or micro-cores of a central processing unit (CPU) and/or a graphics processing unit (GPU). The computing system (600) may also include one or more input devices (610), such as a touchscreen, keyboard, mouse, microphone, touchpad, electronic pen, or any other type of input device. Further, the communication interface (612) may include an integrated circuit for connecting the computing system (400) to a network (not shown) (e.g., a local area network (LAN), a wide area network (WAN) such as the Internet, mobile network, or any other type of network) and/or to another device, such as another computing device.

In one or many embodiment(s) described herein, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments described herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for utterance classification, the method comprising:
receiving an unclassified utterance;
processing the unclassified utterance to produce a politeness score;
analyzing the unclassified utterance to produce a key linguistic terms count;
making a first determination that the politeness score exceeds a politeness score threshold;
making a second determination, based on the first determination, that the key linguistic terms count exceeds a key linguistic terms count threshold; and
classifying, based on the second determination, the unclassified utterance as a polite utterance.

2. The method of claim 1, wherein the unclassified utterance is processed using a politeness learning model comprising an ensemble of transformer models.

3. The method of claim 1, wherein the unclassified utterance is analyzed using part-of-speech (POS) tagging.

4. The method of claim 3, wherein the unclassified utterance comprises a set of words, and wherein the key linguistic terms count reflects a cardinality of a subset of the set of words belonging to at least one grammatical category associated with politeness.

5. The method of claim 4, wherein the at least one grammatical category comprises adjectives and pronouns.

6. The method of claim 1, the method further comprising:
prior to receiving the unclassified utterance:
accessing a corpus of impolite utterances comprising impolite utterance samples;
accessing a corpus of polite utterances comprising polite utterance samples; and
optimizing, through training of, the politeness learning model using the impolite utterance samples and the polite utterance samples.

7. The method of claim 6, wherein the politeness score quantifies a similarity of the unclassified utterance to the corpus of polite utterances.

8. The method of claim 1, the method further comprising:
after classifying the unclassified utterance:
receiving a second unclassified utterance;
processing the second unclassified utterance to produce a second politeness score;
analyzing the second unclassified utterance to produce a second key linguistic terms count;
making a third determination that the second politeness score exceeds the politeness score threshold;
making a fourth determination, based on the third determination, that the second key linguistic terms count equals or falls below the key linguistic terms count threshold; and
classifying, based on the fourth determination, the second unclassified utterance as an impolite utterance.

9. The method of claim 1, the method further comprising:
after classifying the unclassified utterance:
receiving a second unclassified utterance;
processing the second unclassified utterance to produce a second politeness score;
making a third determination that the second politeness score equals or falls below the politeness score threshold; and
classifying, based on the third determination, the second unclassified utterance as an impolite utterance.

10. A non-transitory computer readable medium (CRM) comprising computer readable program code, which when executed by a computer processor, enables the computer processor to perform a method for utterance classification, the method comprising:
receiving an unclassified utterance;
processing the unclassified utterance to produce a politeness score;
analyzing the unclassified utterance to produce a key linguistic terms count;
making a first determination that the politeness score exceeds a politeness score threshold;
making a second determination, based on the first determination, that the key linguistic terms count exceeds a key linguistic terms count threshold; and
classifying, based on the second determination, the unclassified utterance as a polite utterance.

11. The non-transitory CRM of claim 10, wherein the unclassified utterance is processed using a politeness learning model comprising an ensemble of transformer models.

12. The non-transitory CRM of claim 10, wherein the unclassified utterance is analyzed using part-of-speech (POS) tagging.

13. The non-transitory CRM of claim 12, wherein the unclassified utterance comprises a set of words, and wherein the key linguistic terms count reflects a cardinality of a subset of the set of words belonging to at least one grammatical category associated with politeness.

14. The non-transitory CRM of claim 13, wherein the at least one grammatical category comprises adjectives and pronouns.

15. The non-transitory CRM of claim 10, the method further comprising:
prior to receiving the unclassified utterance:
accessing a corpus of impolite utterances comprising impolite utterance samples;
accessing a corpus of polite utterances comprising polite utterance samples; and
optimizing, through training of, the politeness learning model using the impolite utterance samples and the polite utterance samples.

16. The non-transitory CRM of claim 15, wherein the politeness score quantifies a similarity of the unclassified utterance to the corpus of polite utterances.

17. A method for out-of-distribution data generalization, the method comprising:
selecting, of a polite dialog service, a polite dialog service module comprising module weights;
creating a new polite dialog service module comprising new module weights;
processing a first portion of a module input-target sample using the polite dialog service module to produce a module prediction value;
processing a second portion of the module input-target sample using the new polite dialog service module to produce a new module prediction value;
computing a de-biasing loss from the module prediction value, the new module prediction value, and a third portion of the module input-target sample;
making a determination that the de-biasing loss falls below a de-biasing loss threshold; and
deeming, based on the determination, the polite dialog service module as generalized for out-of-distribution data.

18. The method of claim 17, wherein the first portion of the module input-target sample comprises a set of input values accepted by the polite dialog service module, and wherein the set of input values pertain to an existing knowledge domain supported by the polite dialog service.

19. The method of claim 18, wherein the second portion of the module input-target sample comprises a second set of input values accepted by the new polite dialog service module, and wherein the second set of input values pertain to a new knowledge domain yet to be supported by the polite dialog service.

20. The method of claim 19, wherein the third portion of the module input-target sample comprises a target value that commonly corresponds to the first and second sets of input values, and wherein the target value pertains to the existing and new knowledge domains.
